(19) United States
(12) Patent Application Publication
(10) Pub. No.: US 2025/0272661 A1
(43) Pub. Date: Aug. 28, 2025

(54) DIGITAL PRODUCT MANAGEMENT SUPPORT METHOD, DIGITAL PRODUCT MANAGEMENT SUPPORT DEVICE, DIGITAL PRODUCT MANAGEMENT SUPPORT PROGRAM, AND DIGITAL PRODUCT MANAGEMENT SUPPORT SYSTEM

(71) Applicant: Toshihiro Nishino, Tokyo (JP)

(72) Inventor: Toshihiro Nishino, Tokyo (JP)

(21) Appl. No.: 19/043,937

(22) Filed: Feb. 3, 2025

(30) Foreign Application Priority Data
Feb. 26, 2024 (JP) 2024-026345

(51) Int. Cl. G06Q 10/10; G06F 16/23; G06Q 20/06; G06Q 20/42

(52) U.S. Cl. CPC G06Q 10/103; G06F 16/2379; G06Q 20/06; G06Q 20/42

(57) ABSTRACT

A dealing terminal requests a distributed ledger system to register a transaction including owner information in which a purchaser of a digital product is an owner and a fact that a seller of the digital product has a right to claim payment for the digital product. When a deposit notification of a purchase amount of the digital product is received, the dealing terminal requests the distributed ledger system to register a transaction including the fact that the seller of the digital product does not have the right to claim payment for the digital product. When an actual product is sold, the dealing terminal requests the distributed ledger system to register a transaction including the fact that the purchaser of the actual product is the owner of the digital product and a location of the actual product is registered as a location of the digital product.

### CROSS-REFERENCE TO RELATED APPLICATIONS

This application is based upon and claims the benefit of priority from prior Japanese Patent Application No. 2024-026345, filed on Feb. 26, 2024, the entire contents of which are incorporated herein by reference.

### BACKGROUND

### 1. Field

The present disclosure relates to a digital product management support method, a digital product management support device, a digital product management support program, and a digital product management support system.

### 2. Description of Related Art

Fund raising methods include various methods such as bond issuance, borrowing, lending, and factoring. For example, in factoring disclosed in Japanese Laid-Open Patent Publication No. 2002-109224, a procedure for factoring accounts receivable is implemented by a computer digital product management support system.

In factoring, accounts receivable (receivables) generated when a business operator sells products are collateral. The business operator can raise funds when a factoring company purchases the accounts receivable. In this case, the business operator is provided with the amount obtained by subtracting a fee as funds from the factoring company.

After the funds are raised, the business operator is paid accounts receivable from purchasers of the products. Thereafter, the business operator pays these accounts receivable to the factoring company. In the e-commerce support system of the above document, it is possible to reduce the burden of clerical work and to promptly purchase accounts receivable.

In the above-described factoring, the issuance of an invoice after the sale of a product is a precondition. For this reason, funds cannot be raised until accounts receivable (receivables) are generated. A business operator having products may wish to raise funds before selling the products. However, with the factoring, it is difficult to raise funds before selling products.

An objective of the present disclosure is to provide a digital product management support method, a digital product management support device, a digital product management support program, and a digital product management support system that enable a business operator having a product to raise funds before the business operator sells the product.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with a first aspect of the present disclosure, a digital product management support method for causing a computer of a dealing terminal to execute the following steps upon dealing of a digital product associated with an actual product is provided. The method includes: when there is a commercial dealing of the digital product, requesting, by the computer, a database entity under a communication network to register a transaction including owner information in which a purchaser of the digital product is a new owner of the digital product and a fact that a seller of the digital product has a right to claim payment for the digital product; in a case in which a deposit notification of a purchase amount of the digital product from the purchaser of the digital product is received via the communication network, requesting, by the computer, the database entity to register a transaction including a fact that the seller of the digital product does not have the right to claim payment; in a case in which the actual product is sold, requesting the database entity to register a transaction including a fact that the purchaser of the actual product is an owner of the digital product and a location of the actual product is registered as a location of the digital product; and on a payment due date according to a sales contract with the purchaser of the digital product based on the dealing of the digital product, notifying, by the computer, a terminal of a financial institution of payment of a sales amount of the digital product to an account of the purchaser of the digital product via the communication network.

In the present specification, dealing information of commercial dealing is referred to as a transaction.

In accordance with a second aspect of the present disclosure, a digital product management support device communicable with multiple terminals and a database entity via a communication network and configured to support management of dealing of a digital product associated with an actual product is provided. The device includes a first registration request unit, a second registration request unit, a third registration request unit, and a payment notification unit. The first registration request unit includes a processor configured to, when there is a commercial dealing of the digital product, request the database entity under the communication network to register a transaction including owner information in which a purchaser of the digital product is a new owner of the digital product and a fact that a seller of the digital product has a right to claim payment for the digital product. The second registration request unit includes a processor configured to, in a case in which a deposit notification of a purchase amount of the digital product from the purchaser of the digital product is received via the communication network, request the database entity to register a transaction including a fact that the seller of the digital product does not have the right to claim payment. The third registration request unit includes a processor configured to, in a case in which the actual product is sold, request the database entity to register a transaction including a fact that the purchaser of the actual product is an owner of the digital product and a location of the actual product is registered as a location of the digital product. The payment notification unit includes a processor configured to request a terminal of a financial institution to pay a sales amount of the digital product to an account of the purchaser of the digital product via the communication network on a payment due date according to a sales contract with the purchaser of the digital product based on the dealing of the digital product.

In accordance with a third aspect of the present disclosure, a computer-readable medium recording a digital product management support program implemented by multiple terminals and a computer communicable with a database entity via a communication network is provided. The digital product management support program includes an instruction that causes the computer to: when there is a commercial dealing of a digital product associated with an actual product, request the database entity under the communication network to register a transaction including owner information in which a purchaser of the digital product is a new owner of the digital product and a fact that a seller of the digital product has a right to claim payment for the digital product; in a case in which a deposit notification of a purchase amount of the digital product from the purchaser of the digital product is received via the communication network, request the database entity to register a transaction including a fact that the seller of the digital product does not have the right to claim payment; in a case in which the actual product is sold, request the database entity to register a transaction including a fact that the purchaser of the actual product is an owner of the digital product and a location of the actual product is registered as a location of the digital product; and notify a terminal of a financial institution of payment of a sales amount of the digital product to an account of the purchaser of the digital product via the communication network on a payment due date according to a sales contract with the purchaser of the digital product based on the dealing of the digital product.

In accordance with a fourth aspect of the present disclosure, a digital product management support system is provided that includes a digital product management support device, multiple terminals, and a database entity that are connected via a communication network. The digital product management support device includes a first registration request unit, a second registration request unit, a third registration request unit, and a payment notification unit. The first registration request unit includes a processor configured to, when there is a commercial dealing of a digital product associated with an actual product, request the database entity under the communication network to register a transaction including owner information in which a purchaser of the digital product is a new owner of the digital product and a fact that a seller of the digital product has a right to claim payment for the digital product. The second registration request unit includes a processor configured to, in a case in which a deposit notification of a purchase amount of the digital product from the purchaser of the digital product is received via the communication network, request the database entity to register a transaction including a fact that the seller of the digital product does not have the right to claim payment. The third registration request unit includes a processor configured to, in a case in which the actual product is sold, request the database entity to register a transaction including a fact that the purchaser of the actual product is an owner of the digital product and a location of the actual product is registered as a location of the digital product. The payment notification unit includes a processor configured to request a terminal of a financial institution to pay a sales amount of the digital product to an account of the purchaser of the digital product via the communication network on a payment due date according to a sales contract with the purchaser of the digital product based on the dealing of the digital product. The database entity is configured to perform processing according to a registration request of the first registration request unit, a registration request of the second registration request unit, and a registration request of the third registration request unit.

Other features and aspects will be apparent from the following detailed description, the drawings, and the claims.

### BRIEF DESCRIPTION OF THE DRAWINGS

FIG. 1 is a block diagram illustrating a configuration of a digital product management support system according to a first embodiment of the present disclosure.

FIG. 2 is a block diagram illustrating a configuration of each of a dealing terminal and a terminal of the first embodiment.

FIG. 3 is a sequence diagram illustrating an outline of digital product management support of the first embodiment.

FIG. 4 is a sequence diagram illustrating the outline of the digital product management support of the first embodiment.

FIG. 5 is a sequence diagram illustrating an outline of digital product management support of a second embodiment.

FIG. 6 is a sequence diagram illustrating the outline of the digital product management support of the second embodiment.

FIG. 7 is a sequence diagram illustrating the outline of the digital product management support of the second embodiment.

FIG. 8 is a block diagram illustrating a configuration of a digital product management support system according to a third embodiment.

FIG. 9 is a sequence diagram illustrating an outline of the digital product management support of the third embodiment.

FIG. 10 is a sequence diagram illustrating the outline of the digital product management support of the third embodiment.

FIG. 11 is a sequence diagram illustrating the outline of the digital product management support of the third embodiment.

FIG. 12 is a sequence diagram illustrating an outline of digital product management support of a fourth embodiment.

FIG. 13 is a sequence diagram illustrating the outline of the digital product management support of the fourth embodiment.

FIG. 14 is a sequence diagram illustrating the outline of the digital product management support of the fourth embodiment.

FIG. 15 is a sequence diagram illustrating the outline of the digital product management support of the fourth embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

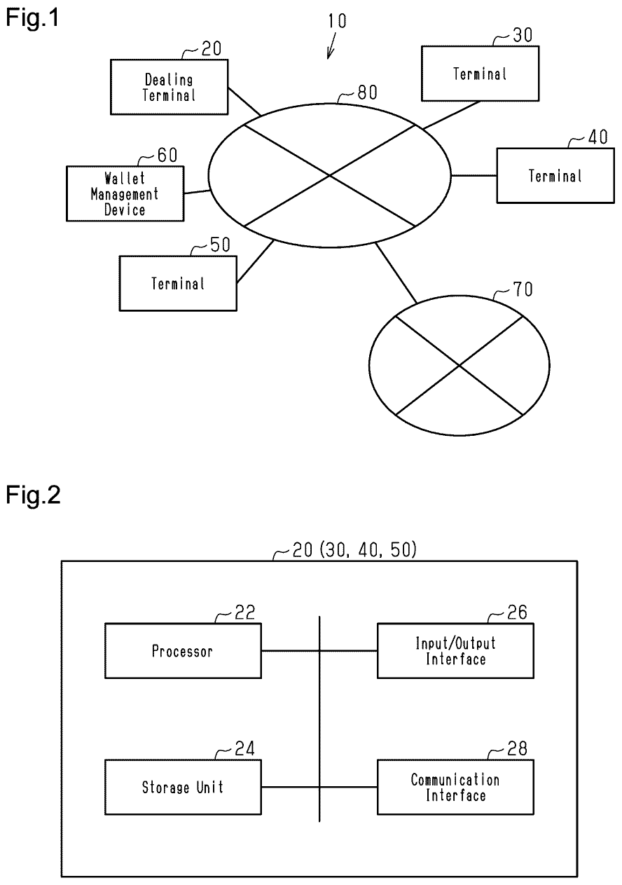

Hereinafter, a first embodiment embodying the present disclosure will be described with reference to FIGS. 1 to 4.

### 1. Digital Product Management Support System

As illustrated in FIG. 1, a digital product management support system 10 includes a dealing terminal 20, terminals 30, 40, and 50, a wallet management device 60, and a distributed ledger system 70. Although three terminals 30, 40, and 50 are shown for illustrative purposes, four or more terminals may be provided.

The dealing terminal 20, the terminals 30, 40, and 50, the wallet management device 60, and the distributed ledger system 70 are connected via a communication network 80. The communication network 80 includes, for example, the Internet, a wide area network (WAN), and the like.

### 1.1. Dealing Terminal 20, Terminals 30, 40, 50

In the present embodiment, the dealing terminal 20 and the terminals 30, 40, and 50 are formed by personal computers. The dealing terminal 20 and the terminals 30, 40, and 50 may be formed by smartphones or tablet terminals. As illustrated in FIG. 2, the dealing terminal 20 includes a processor 22, a storage unit 24, an input/output interface 26, and a communication interface 28. The dealing terminal 20 corresponds to a digital product management support device. A personal computer forming the dealing terminal 20 corresponds to a computer of the present disclosure.

The processor 22 includes memories such as a central processing unit (CPU), a read-only memory (ROM), and a random access memory (RAM) (not illustrated). The processor 22 includes a ROM (not illustrated) that stores an operating system (OS) program for managing the entire system of the device that is the dealing terminal 20 itself, a RAM (not illustrated) serving as a work memory, and a CPU (not illustrated).

Instead of the CPU, an application specific integrated circuit (ASIC) or a field programmable array (FPGA) may be used. The processor 22 corresponds to a first registration request unit, a second registration request unit, a third registration request unit, and a payment notification unit.

The storage unit 24 is formed by a rewritable storage medium such as a hard disk or a solid state drive (SSD). The storage unit 24 stores a digital product management support program, an application program such as a web browser, and various data acquired by execution processing of the digital product management support program.

Various input devices and output devices (both not illustrated) are connected to the input/output interface 26. The input devices include a keyboard, a touch panel, and a pointing device such as a mouse. The output devices include a display, a speaker, and a printer.

The communication interface 28 controls communication between the dealing terminal 20 and the wallet management device 60 and the distributed ledger system 70 via the communication network 80. The communication interface 28 corresponds to a communication unit.

Since the terminals 30, 40, and 50 have the same configuration as that of the dealing terminal 20, as illustrated in FIG. 2, “(30, 40, 50)” is added after the reference numeral “20” of the dealing terminal 20, and the description thereof is omitted.

Business operators who use the dealing terminal 20 and the terminals 30, 40, and 50 are both users who are qualified to participate in the distributed ledger system 70. The business operators are individuals or corporations. These business operators can check the content of transactions of blocks of a blockchain by inputting the respective identifiers and passwords of the business operators using the input devices of the dealing terminal 20 and the terminals 30, 40, and 50.

The password is preferably a public key cryptosystem.

### 1.2. Wallet Management Device 60

The wallet management device 60 is a management server of a financial institution such as a bank. In FIG. 2, for illustrative purposes, one wallet management device 60 is representatively shown, but it should be understood that multiple wallet management devices 60 are connected to the communication network 80. A case will now be described in which a payment instruction from an account of a business operator to an account of another business operator has been issued from any one of the dealing terminal 20 and the terminals 30, 40, and 50 to one wallet management device 60 due to a commercial dealing. Then, the wallet management device 60 remits money from the account of the business operator who has given the payment instruction to another wallet management device that manages the account of the other business operator according to the payment instruction.

In this manner, in a commercial dealing of a product and a digital product associated with the product, which will be described later, the wallet management device 60 manages an account of a purchaser used for payment for the amounts of the product and the digital product.

### 1.3. Distributed Ledger System 70

In the distributed ledger system 70, multiple node computers are connected to each other wirelessly or by wire via a P2P network. The P2P network is a single configuration such as a public network, a dedicated line, or a virtual private network (VPN), or a combination thereof. The node computers each include a processor, a storage unit, an input/output interface, and a communication interface similar to those of the dealing terminal 20 illustrated in FIG. 2. In the present embodiment, the dealing terminal 20 and the terminals 30, 40, and 50 are also included in the node computers forming the distributed ledger system 70.

The distributed ledger system 70 corresponds to a database entity. Each of the node computers manages a distributed ledger in a blockchain. In other words, when acquiring the transaction for which registration has been requested, the node computer generates a block including the transaction, and links the generated block to an already-generated blockchain in a chain manner. As a result, the blockchain has a data structure in which the generated blocks are connected in time series. Examples of the blockchain include bitcoin (registered trademark) and Ethereum (registered trademark).

Hereinafter, a consensus algorithm will be described using proof of work (PoW) as an example. The consensus algorithm may be proof of stake (POS) or proof of importance (PoI).

A block has an area for storing various data such as an identifier of the block, a transaction acquired at a generation time interval of the block, a timestamp at which the transaction is acquired in the block, and each hash value of the block and the block generated last time.

The identifier is a serial number that is added one by one each time a new block is connected to the blockchain. By referring to the latest hash value of the blockchain, it is possible to publicly verify whether the blockchain has been tampered.

The block has multiple transactions. The block is time-series data in which multiple transactions are arranged according to the timestamp of the transaction. In this manner, the transaction is associated with a timestamp.

An actual product and a digital product can be sold separately. The actual product and the digital product are associated with each other. When the actual product is sold and the deposit of the sales price of the actual product is confirmed, the ownership of the digital product is transferred to the purchaser of the actual product.

The node computer generates a block by successfully searching (mining) for a nonce satisfying a predetermined condition every predetermined time. Blocks generated by one node computer are chained into an existing blockchain upon approval by another node computer. The blockchain thus updated is shared by the node computers connected to the P2P network. As a result, the blockchain becomes a database that stores multiple transactions (dealing information (including a dealing history)) in the P2P network.

A mining reward is given to a node computer that has first generated a block by successfully searching for a nonce. Examples of the mining reward include, but are not limited to, a cryptographic asset. For example, a mining reward may be paid by a business operator who manages a block chain.

### Database by Distributed Ledger System 70

Registration of a transaction in the distributed ledger system 70 forms a database related to an actual product and a digital product to be sold.

The database includes, for each transaction, transaction related information and digital product related information to be described later. The transaction related information and the digital product related information for each transaction will be described later.

### Operation of First Embodiment

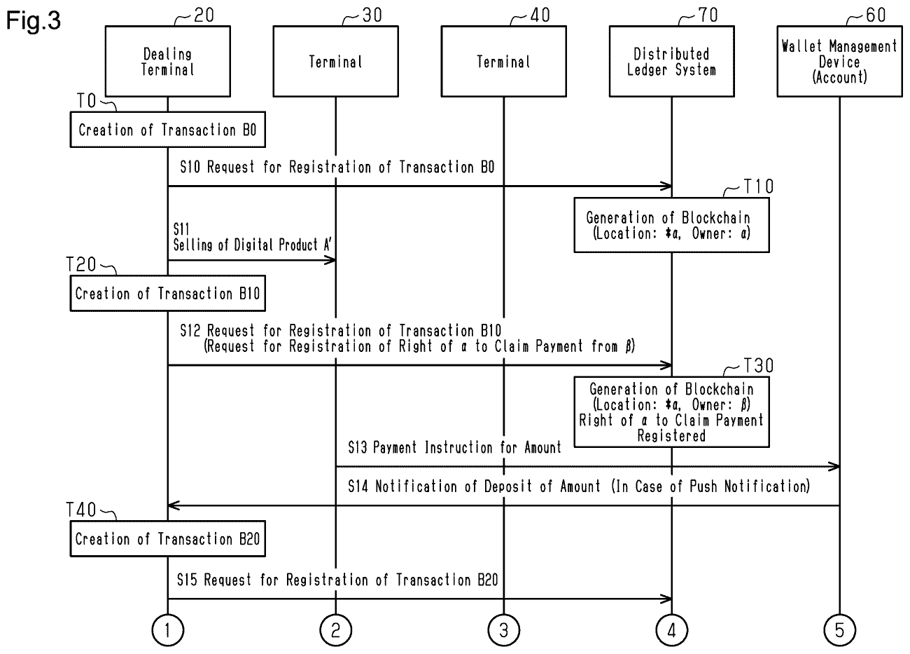

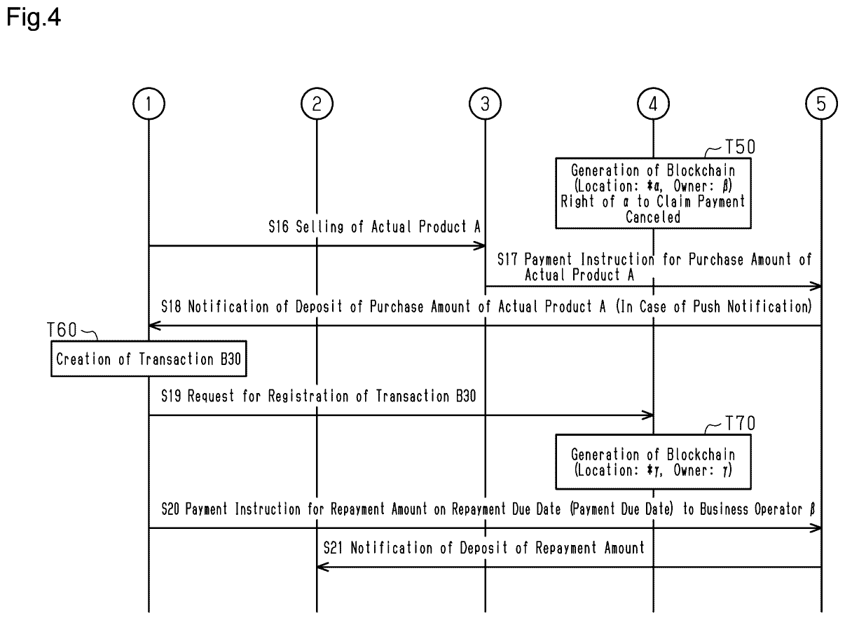

Next, operation of the digital product management support system 10, the dealing terminal 20, and the digital product management support program of the present embodiment will be described with reference to FIGS. 3 and 4. FIGS. 3 and 4 are sequence diagrams illustrating an outline of digital product management support.

Hereinafter, an actual product is denoted by a reference sign A. A digital product is denoted by a reference sign A″. In addition, *α is attached to the location of an actual product. A digital product A′ is collateralized by its actual product A.

In addition, a is assigned to the business operator of the dealing terminal 20, β is assigned to the business operator of the terminal 30, γ is assigned to the business operator of the terminal 40, and β″ is assigned to the business operator of the terminal 50. In addition, the business operator who uses the dealing terminal 20 is referred to as a vendor who sells the actual product A and the digital product A″. The vendor is a business operator who raises funds by selling the digital product A″. The business operator who uses the terminal 30 is a business operator who purchases the digital product A″ to fund the vendor. The business operator γ who uses the terminal 40 is a purchaser of the actual product A.

### T0: Creation of Transaction B0

As illustrated in FIG. 3, the dealing terminal 20 of the vendor (business operator α) creates a transaction B0. The creation of a transaction B10 is performed by an input operation or the like of an input device of the dealing terminal 20. The transaction B0 includes the following (1) transaction related information, (2) digital product related information, and (3) actual product related information.

The business operator α assigns individual management (unique serial number) for managing a product such as an RFID tag or a QR code (registered trademark) to the actual product A, and manages the stock of the actual product A and the digital product A′. That is, the actual product A and the digital product A′ are managed in a one-to-one linked state to avoid overlapping.

### Transaction B0

(1) Since the sale has not been completed, the various types of information included in the transaction related information is default data unlike the transaction B10 to be described later.

(2) Digital product related information: an image and an identifier of the digital product A′, the owner of the digital product A′, the purchase amount (trade price) of the digital product A′, and the location of the digital product A′. The image of the digital product A′ only needs to be able to identify the digital product A′, and is not necessarily limited to a captured image of the actual product A.

(3) Actual product related information: the name of the actual product A associated with the digital product A′, the identifier of the actual product A, the cost price of the actual product A, the sales price of the actual product A, and the location of the actual product A.

In B0, the owner of the digital product A′ is the vendor (business operator α). The location *α of the digital product A′ is the same as the location of the actual product A. Therefore, in B0, the location of the digital product A′ is the location of the vendor who owns the actual product A. The location of the digital product A′ corresponds to the location information of the digital product A′. The owner of the digital product A′ corresponds to the owner information of the digital product A′.

### S10: Request Registration of Transaction B0

As described above, when the transaction B0 is created, the digital product management support program causes the dealing terminal 20 to request the distributed ledger system 70 to register the transaction B0 via the communication network 80.

### T10: Generation of Blockchain

In the distributed ledger system 70, when the registration of the transaction B0 is requested, generation of a block including the transaction B0 and generation of a blockchain are performed. As a result, the location *α of the digital product A′ and the fact that the owner of the digital product A′ is the vendor (business operator α) are registered in the database of the distributed ledger system 70.

### S11: Selling of Digital Product A′

As illustrated in FIG. 3, when a sales contract is established between the vendor (business operator α) and a business operator (business operator β) who wishes to purchase the digital product A′, digital data including an image of the digital product A′ and the like, and a delivery slip and an invoice are transmitted from the dealing terminal 20 to the terminal 30. This transmission is executed by the processor 22 of the dealing terminal 20 when an input device connected to the input/output interface 26 is operated. The delivery of the digital data including the image of the digital product A′ and the like, and the delivery of the delivery slip and the invoice from the dealing terminal 20 to the terminal 30 means the sale of the digital product A′.

The commercial dealing between the business operator α and the business operator β may be either face-to-face dealing or dealing on a website provided by a server (not illustrated) connected to the communication network 80.

Therefore, the business operator β can confirm the content of the transaction of the block of the blockchain by inputting the identifier and the password of the business operator β using the input devices of the terminal 30. That is, the business operator β can confirm the content of the digital product A′ when purchasing the digital product A′.

### T20: Creation of Transaction B10

As illustrated in FIG. 3, after the sale of the digital product A′ is completed, the dealing terminal 20 creates the transaction B10. The creation of the transaction B10 is performed by an input operation or the like of the input device of the dealing terminal 20.

The transaction B10 includes the following (1) transaction related information, (2) digital product related information, and (3) actual product related information.

### Transaction B10

(1) Transaction related information: an identifier of a transaction, and sales contract content information between the business operators α and β.

The contract information includes the following information.

Identifiers of the business operators α and β, dealing conclusion date and time (purchase date and time), a payment due date of a purchase amount of the digital product A′ from the business operator β to the business operator α, a payment due date of a repayment amount X from the business operator α to the business operator β, a payment rate π to a purchaser (business operator β) of the digital product A′, information indicating that a seller of the digital product A′ has a right to claim payment (monetary claim) for the digital product A′, and the like.

(2) The digital product related information includes an image and an identifier of the digital product A′, owner information of the digital product A′, the location *α of the digital product A′, and the purchase amount of the digital product A′ (trade price D: D=X (1−π)).

X is the price of the digital product A′ and the repayment amount from the vendor (business operator α) to the purchaser (business operator β) of the digital product A′. π is the payment rate, that is, the discount rate from the vendor (business operator α) to the purchaser of the digital product A′.

In the transaction B10, it is indicated that the owner of the digital product A′ is the business operator β. The owner of the digital product A′ corresponds to the owner information of the digital product A′.

(3) Actual product related information: the name of the actual product A associated with the digital product, the identifier of the actual product A, the cost price of the actual product A, the sales price of the actual product A, and the location of the actual product A.

In the transaction B10, the location of the actual product A is the location *α of the vendor who owns the actual product A.

### S12: Request for Registration of Transaction B10

As described above, when the transaction B10 is created, the digital product management support program causes the dealing terminal 20 to request the distributed ledger system 70 to register the transaction B10 via the communication network 80.

The registration request includes a registration request of the owner information of the digital product A′ in which the purchaser of the digital product A′ is the new owner of the digital product A′, and a registration request indicating that the seller of the digital product A′ has the right to claim payment for the digital product A′.

### T30: Generation of Blockchain

In the distributed ledger system 70, when registration of the transaction B10 is requested, generation of a block including the transaction B10 and generation of a blockchain are performed.

By the transaction B10, the location *α of the digital product A′, information indicating that the owner of the digital product A′ is the purchaser (business operator β) of the digital product A′, and that the seller of the digital product A′ has the right to claim payment for the digital product A′ are registered in the database of the distributed ledger system 70.

The fact that the transaction is associated with the timestamp means that the location *α and the owner information of the digital product A′ are associated with the timestamp. It should be noted that, in the following description of the generation of the block chain, the location and the owner information of the digital product A′ are associated with the timestamp added to the transaction in this manner.

### S13: Payment Instruction for Amount

In S13, the terminal 30 of the business operator β instructs the wallet management device 60 to pay the purchase amount (trade price D) of the digital product A′ to the vendor (business operator α) via the communication network 80. In response to the payment instruction, the wallet management device 60 remits money from the account of the business operator who has given the payment instruction to another wallet management device that manages the account of the vendor (business operator α).

### S14: Notification of Deposit of Amount

In S14, a deposit notification (for example, push notification) of the amount from the business operator β is received via the other wallet management device to the account of the vendor via the communication network 80. The currency to be deposited in the account is a stablecoin or cash. A stablecoin is a currency for which price fluctuation is stabilized by having legal currency, virtual currency, gold, or the like as collateral. Wallet depositing in the following other steps is similarly performed with a stablecoin or cash.

### T40: Creation of Transaction B20

As illustrated in FIG. 3, when a notification of deposit of the amount from the business operator β to the account of the vendor is received via the communication network 80, the digital product management support program causes the dealing terminal 20 to create a transaction B20.

### Transaction B20

The transaction B10 has information indicating that the seller of the digital product A′ has the right to claim payment for the digital product A′. On the other hand, the transaction B20 has information indicating that the seller of the digital product A′ does not have the right to claim payment for the digital product A′. In this respect, the transaction B20 is different from the transaction B10. In the transaction B20, other information except for the information indicating that there is no right to claim payment for the digital product A′, that is, the transaction related information, the digital product related information, and the actual product related information are similar to those in the transaction B10, and thus, description thereof is omitted.

Therefore, in the transaction B20, similarly to the transaction B10, the owner of the digital product A′ is the purchaser (business operator β), and there is no change from the transaction B10. In the transaction B20, the location *α of the digital product A′ is not changed from the transaction B10.

The location *α of the digital product A′ corresponds to the location information of the digital product A′.

### S15: Request for Registration of Transaction B20

As described above, when the transaction B20 is created, the digital product management support program causes the dealing terminal 20 to request the distributed ledger system 70 to register the transaction B20 via the communication network 80.

The registration request includes a registration request indicating that the seller of the digital product A′ does not have the right to claim payment for the digital product A′.

### T50: Generation of Blockchain

In T50, in the distributed ledger system 70, when registration of the transaction B20 is requested, generation of a block including the transaction B20 and generation of a blockchain are performed.

By the transaction B20, the location *α of the digital product A′, information indicating that the owner of the digital product A′ is the purchaser (business operator β) of the digital product A′, and that the seller of the digital product A′ does not have the right to claim payment for the digital product A′ are registered in the database of the distributed ledger system 70.

### S16: Selling of Actual Product A

As illustrated in FIGS. 3 and 4, in a case in which a commercial dealing between the vendor (business operator α) and a business operator (business operator γ) who wishes to purchase the actual product A, that is, a sales contract is established, a delivery slip and an invoice of the actual product A are transmitted from the dealing terminal 20 to the terminal 40. This transmission is executed by the processor 22 of the dealing terminal 20 when an input device connected to the input/output interface 26 is operated. The delivery of the delivery slip and the invoice of the actual product A from the dealing terminal 20 to the terminal 40 means the sale of the actual product A.

The commercial dealing between the business operator α and the business operator γ may be either face-to-face dealing or dealing on a website provided by a server (not illustrated) connected to the communication network 80.

### S17: Payment Instruction for Purchase Amount of Actual Product A

In S17, the terminal 40 of the business operator γ instructs the wallet management device 60 to pay the purchase amount (trade price D) of the actual product A to the vendor (business operator α) via the communication network 80. In response to the payment instruction, the wallet management device 60 remits money from the account of the business operator who has given the payment instruction to another wallet management device that manages the account of the vendor (business operator α).

### S18: Notification of Deposit of Purchase Amount of Actual Product A

In S18, a notification (for example, push notification) of deposit of the amount from the business operator γ is received via the other wallet management device to the account of the vendor via the communication network 80.

### T60: Creation of Transaction B30

When a notification of deposit of the amount from the business operator γ to the account of the vendor is received via the communication network 80, the digital product management support program causes the dealing terminal 20 to create a transaction B30.

The transaction B30 includes the following (1) transaction related information, (2) digital product related information, and (3) actual product related information.

### Transaction B30

(1) Transaction related information: an identifier of a transaction, and sales contract content information between the business operators α and β (including identifiers of a vendor and a purchaser, a dealing conclusion date and time (purchase date and time), a payment date of a purchase amount of the actual product A from the purchaser to the vendor, and the like). In addition, the transaction related information also includes information indicating that there is no right to claim payment for the digital product A′.

(2) Digital product related information: an image and an identifier of the digital product A′, the owner of the digital product A′, the purchase amount (trade price) of the digital product A′, and the location of the digital product A′. In S18, the notification of the deposit of the amount from the business operator γ is confirmed. As a result, the ownership of the digital product A′ is transferred to the purchaser (business operator γ) of the actual product A. Therefore, in the transaction B30, the owner of the digital product A′ is the purchaser of the actual product A (business operator γ), and the location of the digital product A′ is the location of the purchaser (business operator γ) who has purchased the actual product A from the vendor.

(3) Actual product related information: the name of the actual product A associated with the digital product, the identifier of the actual product A, the cost price of the actual product A, the sales price of the actual product A, and the location of the actual product A.

### S19: Request for Registration of Transaction B30

As described above, when the transaction B30 is created, the digital product management support program causes the dealing terminal 20 to request the distributed ledger system 70 to register the transaction B30 via the communication network 80.

The registration request includes a registration request of owner information of the digital product A′ in which the purchaser (business operator γ) of the actual product A is a new owner of the digital product A′, and a registration request of a location of the digital product A′.

### T70: Generation of Blockchain

In the distributed ledger system 70, when registration of the transaction B30 is requested, generation of a block including the transaction B30 and generation of a blockchain are performed.

By the transaction B30, the location *γ of the digital product A′ and the fact that the owner of the digital product A′ is the purchaser (business operator γ) of the actual product A are registered in the database of the distributed ledger system 70.

### S20: Payment Instruction for Repayment Amount on Repayment Due Date (Payment Due Date) to Business Operator β

In S20, the following is executed by the digital product management support program. That is, on the payment due date of the repayment amount X from the dealing terminal 20 of the business operator α to the purchaser (business operator β) of the digital product A′, the wallet management device 60 is instructed to pay the repayment amount of the digital product A′ to the business operator β via the communication network 80.

In response to the payment instruction, the wallet management device 60 remits money from the account of the business operator who has given the payment instruction to another wallet management device that manages the account of the business operator β.

### S21: Notification of Deposit of Repayment Amount

In S21, a deposit notification (for example, push notification) of the repayment amount from the business operator β is received via the other wallet management device to the terminal 30 of the business operator β via the communication network 80.

The first embodiment has the following features.

(1) A digital product management support method of the present embodiment has the following features.

In S12, the dealing terminal 20 requests the distributed ledger system 70 to register a transaction including owner information of the digital product A′ whose new owner is the purchaser (business operator β) of the digital product A′ and the fact that a seller of the digital product A′ has the right to claim payment.

In addition, in a case in which a deposit notification of the purchase amount of the digital product A′ from the purchaser (business operator β) of the digital product A′ is received through the communication network 80, in S15, the dealing terminal 20 (personal computer) requests the distributed ledger system 70 to register a transaction including the fact that the seller of the digital product A′ does not have the right to claim payment for the digital product A′.

In addition, in a case in which the actual product A is sold, in S19, the dealing terminal 20 requests the distributed ledger system 70 to register a transaction including the fact that the purchaser (business operator γ) of the actual product A is the owner of the digital product A′ and the location of the actual product A is registered as the location of the digital product A′. In addition, in S20, on the payment due date according to the sales contract with the purchaser (business operator β) of the digital product A′, the dealing terminal 20 (personal computer) notifies a terminal of a financial institution via a communication network of the payment of the sales amount of the digital product A′ to the account of the purchaser (business operator β) of the digital product A′.

As a result, with the digital product management support method, it is possible to support fund raising via a communication network before a business operator having a product sells the product.

(2) The dealing terminal 20 (digital product management support device) of the present embodiment includes a first registration request unit, a second registration request unit, a third registration request unit, and a processor 22 serving as a payment notification unit.

When there is a commercial dealing of the digital product A′, the processor 22 requests the distributed ledger system 70 to register owner information of the digital product A′ in which the purchaser of the digital product A′ is a new owner of the digital product A′ and a transaction indicating that the seller of the digital product A′ has the right to claim payment.

In a case in which a deposit notification of the purchase amount of the digital product A′ from the purchaser of the digital product A′ is received via the communication network 80, the processor 22 requests the distributed ledger system 70 to register a transaction including the fact that the seller of the digital product A′ does not have the right to claim payment for the digital product A′.

In addition, in a case in which the actual product A is sold, the processor 22 requests the distributed ledger system 70 to register a transaction including the fact that the purchaser (business operator γ) of the actual product A is the owner of the digital product A′ and the location of the actual product A is registered as the location of the digital product A′.

In addition, on the payment due date according to the sales contract with the purchaser of the digital product A′ based on a dealing of the digital product A′, the processor 22 requests the terminal of the financial institution to pay the sales amount of the digital product A′ to the account of the purchaser (business operator β) of the digital product A′ via the communication network 80.

As a result, with the dealing terminal 20, it is possible to support fund raising via a communication network before a business operator having a product sells the product.

(3) The digital product management support program of the present embodiment causes the dealing terminal 20 (personal computer) communicable with multiple terminals and the distributed ledger system 70 via the communication network 80 to implement the following functions.

First, when there is a commercial dealing of the digital product A′, the distributed ledger system 70 is requested to register owner information of the digital product A′ in which the purchaser (business operator β) of the digital product A′ is a new owner of the digital product A′ and a transaction including the fact that the seller of the digital product A′ has the right to claim payment.

In addition, in a case in which a deposit notification of the purchase amount of the digital product A′ from the purchaser (business operator β) of the digital product A′ is received via the communication network 80, the distributed ledger system 70 is requested to register the fact that the seller of the digital product A′ does not have the right to claim payment for the digital product A′. In addition, in a case in which the actual product A is sold, the distributed ledger system 70 is requested to register a transaction including the fact that the purchaser (business operator γ) of the actual product A is the owner of the digital product A′ and the location of the actual product A is registered as the location of the digital product A′.

In addition, on the payment due date according to the sales contract with the purchaser of the digital product A′ based on a dealing of the digital product A′, the dealing terminal 20 (processor 22) requests the terminal of the financial institution to pay the sales amount of the digital product A′ to the account of the purchaser of the digital product A′ via the communication network 80.

As a result, with the dealing terminal 20 executed by the digital product management support program, it is possible to support fund raising via a communication network before a business operator having a product sells the product.

(4) The database entity is the distributed ledger system 70. Then, when requested to register a transaction, the distributed ledger system 70 associates a timestamp with each transaction. As a result, the distributed ledger system 70 enables determination that the transaction associated with the timestamp is not tampered.

### Second Embodiment

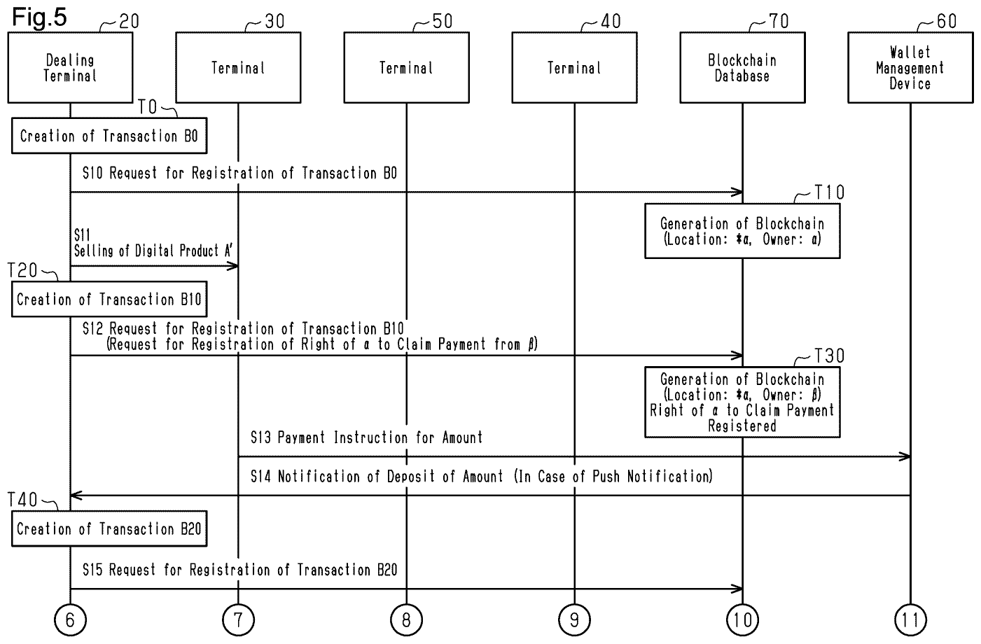

Next, a second embodiment will be described with reference to FIGS. 5 to 7. Since the digital product management support system 10, the dealing terminal 20, the terminals 30, 40, and 50, the wallet management device 60, the distributed ledger system 70, and the communication network 80 have the same configurations as those of the first embodiment, a detailed description thereof will be omitted.

In the present embodiment, the digital product management support program stored in the storage unit 24 (see FIG. 2) of the terminal 30 is executed by the processor 22, whereby a transaction B50 to be described later can be created. In addition, when the digital product management support program is executed by the processor 22, the terminal 30 can request the distributed ledger system 70 to register the transactions B40 and B50 via the communication network 80.

### Operation of Second Embodiment

FIGS. 5 to 7 are sequence diagrams illustrating an outline of digital product management support of the second embodiment.

In the first embodiment, after the digital product A′ is transferred to the business operator β, the business operator β is the owner of the digital product A′ until the day on which the actual product A is sold.

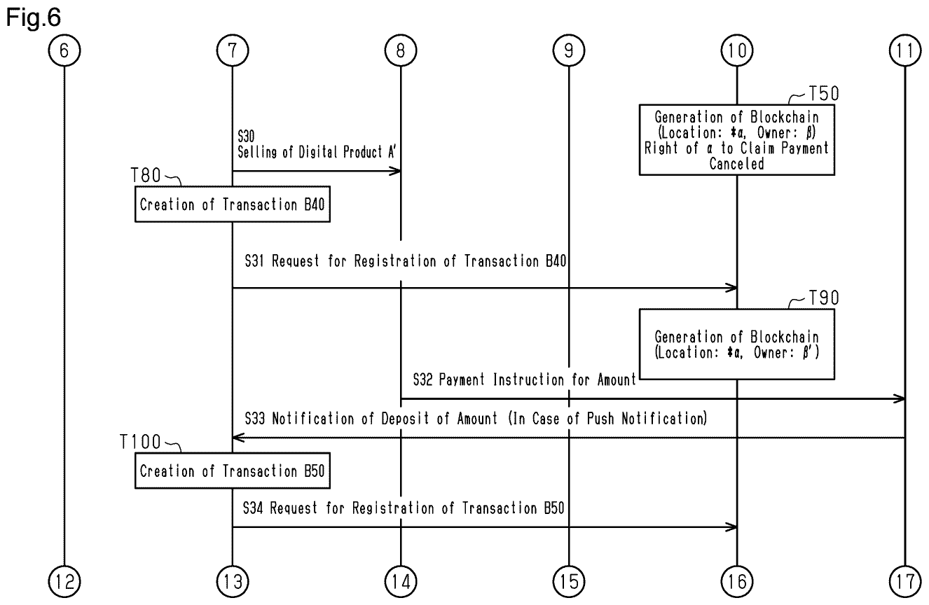

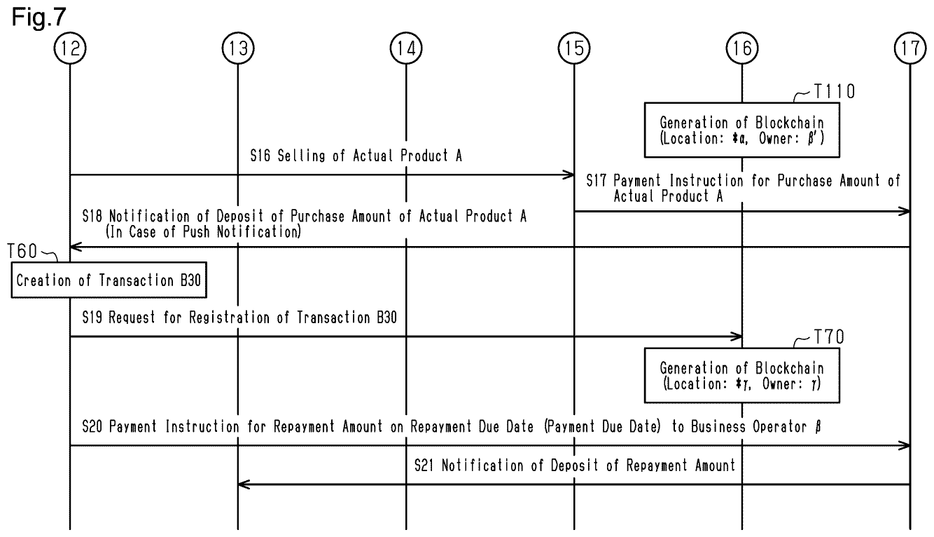

On the other hand, in the present embodiment, a case will be described in which the digital product A′ is transferred from the business operator β to the business operator β′ before the day on which the actual product A is sold after the digital product A′ is transferred to the business operator β. Specifically, in the sequence of FIG. 6, a case will be described in which the digital product A′ is transferred to the business operator β between T50 (Generation of Blockchain) and S16 (Selling of Actual Product A) in FIG. 7. In the sequence diagrams of FIGS. 5 to 7, the same processing as that of the first embodiment are denoted by the same reference numerals, and the description thereof will be omitted.

### S30: Selling of Digital Product A′

As illustrated in FIG. 6, when a sales contract is established between the business operator β and a business operator (business operator β′) who wishes to purchase a new digital product A′, digital data including an image of the digital product A′ and the like, and a delivery slip and an invoice are transmitted from the terminal 30 to the terminal 50. The delivery of the digital data including the image of the digital product A′ and the like, and the delivery of the delivery slip and the invoice from the terminal 30 to the terminal 50 means the sale of the digital product A′.

The commercial dealing between the business operator β and the business operator β′ may be either face-to-face dealing or dealing on a website provided by a server (not illustrated) connected to the communication network 80.

### T80: Creation of Transaction B40

As illustrated in FIG. 6, after the sale of the digital product A′ is completed, the terminal 30 creates the transaction B40. The creation of the transaction B40 is performed by an input operation or the like of the input device of the terminal 30.

The transaction B40 includes the following (1) transaction related information, (2) digital product related information, and (3) actual product related information. Transaction B40

(1) Transaction related information: an identifier of a transaction, and sales contract content information between the business operators β and β′ (identifiers of the business operators β and β′, a dealing conclusion date and time (purchase date and time), a payment due date of a purchase amount of the digital product A′ from the business operator β to the business operator β′).

(2) The digital product related information includes an image and an identifier of the digital product A′, owner information of the digital product A′, the location *α of the digital product A′, and the purchase amount of the digital product A′ (trade price D′: D′=X(1−π′)).

X is the price of the digital product A′ and the repayment amount from the vendor (business operator α) to the purchaser (business operator β) of the digital product A′. π′ is the payment rate, that is, the rate from the vendor (business operator α) to the purchaser of the digital product A′, and takes a positive value or a negative value depending on the market price.

In the transaction B40, it is indicated that the owner of the digital product A′ is the business operator β′. The owner of the digital product A′ corresponds to the owner information of the digital product A′.

(3) Actual product related information: the name of the actual product A associated with the digital product A′, the identifier of the actual product A, the cost price of the actual product A, the sales price of the actual product A, and the location of the actual product A.

In the transaction B10, the location of the actual product A is the location *α of the vendor who owns the actual product A.

### S31: Request for Registration of Transaction B40

As described above, when the transaction B40 is created, the digital product management support program causes the terminal 30 to request the distributed ledger system 70 to register the transaction B40 via the communication network 80.

### T90: Generation of Blockchain

In the distributed ledger system 70, when registration of the transaction B40 is requested, generation of a block including the transaction B40 and generation of a blockchain are performed.

By the transaction B40, the location *α of the digital product A′ and the fact that the owner of the digital product A′ is the business operator β′ are registered in the database of the distributed ledger system 70.

### S32: Payment Instruction for Amount

In S32, the terminal 50 of the business operator β′ instructs the wallet management device 60 to pay the purchase amount (trade price D′) of the digital product A′ to the vendor (business operator β) via the communication network 80. In response to the payment instruction, the wallet management device 60 remits money from the account of the business operator who has given the payment instruction to another wallet management device that manages the account of the vendor (business operator β).

### S33: Notification of Deposit of Amount

In S33, a deposit notification (for example, push notification) of the amount from the business operator β′ is received via the other wallet management device to the account of the vendor via the communication network 80. The currency to be deposited in the account is a stablecoin or cash.

### T100: Creation of Transaction B50

As illustrated in FIG. 6, when a notification of deposit of the amount from the business operator β′ to the account of the vendor via the communication network 80, the digital product management support program causes the terminal 30 to create the transaction B50.

### Transaction B50

In the transaction B50, the history information indicating that the amount has been deposited from the business operator β′ is created, and (1) the transaction related information, (2) the digital product related information, and (3) the actual product related information are created. Since (1) the transaction related information, (2) the digital product related information, and (3) the actual product related information of the transaction B50 are similar to those of the transaction B40, the description thereof will be omitted.

### S34: Request for Registration of Transaction B50

As described above, when the transaction B50 is created, the digital product management support program causes the terminal 30 to request the distributed ledger system 70 to register the transaction B50 via the communication network 80.

### T110: Generation of Blockchain

As illustrated in FIG. 7, in the distributed ledger system 70, when registration of the transaction B50 is requested, generation of a block including the transaction B50 and generation of a blockchain are performed.

By the transaction B50, the history information indicating that the amount has been deposited from the business operator β′, the location *α of the digital product A′, and the fact that the owner of the digital product A′ is the business operator β′ are registered in the database of the distributed ledger system 70.

Hereinafter, in the sequence of FIG. 7, since the processing of S16 to S21, T60, and T70 is similar to that of the first embodiment, the description thereof will be omitted.

The second embodiment has the following effects.

(1) Also in the second embodiment, the same effects as those of the first embodiment are obtained.

With the digital product management support method, when the business operator β is a financial company or a financial intermediary, a product of the business operator α is fluidized to perform financial commercialization such as securitization. As a result, when the business operator β′ is a general investor, the business operator β can sell the digital product A′ that has been financially commercialized to the general investor.

In addition, the business operator β′, who is a general investor, waits for the fund collection from the business operator γ who is an end user, or becomes a member of a group of the business operators γ who are end users, and purchases the actual product A, whereby a dealing of the financial product can be completed.

The business operator γ serving as the end user can also take over the amount scheduled to be paid to the business operator α as liabilities of the business operator γ. In this case, the obligation to fulfil the debt of the business operator α (the obligation to complete the sale of the actual product A and the collection obligation) is transferred to the business operator γ. In such a case, it is sufficient that the business operator β approves. However, since this act is based on the approval of the business operator β, when the business operator γ does not have the ability to pay, the business operator γ does not defraud.

### Modifications of First Embodiment and Second Embodiment

Although not illustrated, modifications of the first embodiment and the second embodiment in a case in which the location of the actual product A is changed before S11 (selling of the digital product A′) will be described.

Each time there is a change in the location of the actual product A before S11 (selling of the digital product A′) in FIGS. 3 and 5, a new transaction B0 is created in the dealing terminal 20. The new transaction B0 includes digital product related information including the changed location of the digital product A′, actual product related information including the changed location of the actual product A, and transaction related information.

Then, the digital product management support program causes the dealing terminal 20 to request the distributed ledger system 70 to register the new transaction B0 via the communication network 80. In response to the registration request of the new transaction B0, the distributed ledger system 70 generates a blockchain.

As a result, the new location *α of the digital product A′ and the fact that the owner of the digital product A′ is the vendor (business operator α) of the digital product A′ are registered in the blockchain.

### Third Embodiment

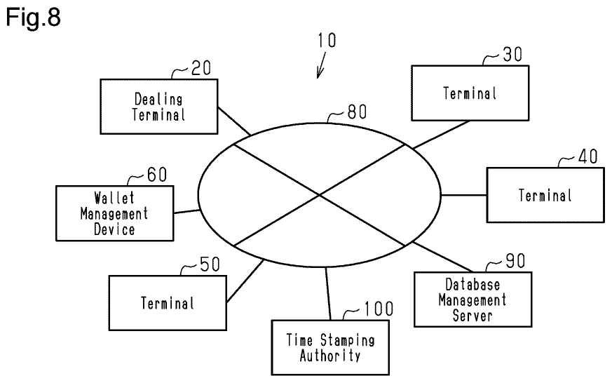

Next, a third embodiment will be described with reference to FIGS. 8 to 11.

### 2.1. Digital Product Management Support System 10

As illustrated in FIG. 8, the digital product management support system 10 of the present embodiment includes the dealing terminal 20, the terminals 30, 40, and 50, the wallet management device 60, a database management server 90, and a time stamping authority 100. Although three terminals 30, 40, and 50 are shown for illustrative purposes, four or more terminals may be provided.

The storage unit 24 (see FIG. 2) of the dealing terminal 20 stores a digital product management support program, an application program such as a web browser, and various data acquired by execution processing of the digital product management support program.

The dealing terminal 20, the terminals 30, 40, and 50, the wallet management device 60, the database management server 90, and the time stamping authority 100 are connected via the communication network 80. The communication network 80 includes, for example, the Internet, a WAN, and the like.

### 2.2. Dealing Terminal 20, Terminals 30, 40, 50

Since the hardware configuration of the dealing terminal 20 and the terminals 30, 40, and 50 is similar to that of the first embodiment, the description thereof will be omitted. Business operators who use the dealing terminal 20 and the terminals 30, 40, and 50 are both users who are qualified to access the database management server 90. These business operators can confirm the content of transactions in a digital product management database stored in the database management server 90 by inputting the respective identifiers and passwords of the business operators using the input devices of the dealing terminal 20 and the terminals 30, 40, and 50. The password is preferably a public key cryptosystem.

The dealing terminal 20 of the present embodiment corresponds to the digital product management support device, and a personal computer constituting the dealing terminal 20 corresponds to the computer of the present disclosure.

### 2.3. Database Management Server 90

The database management server 90 stores the digital product management database including a history of commercial dealings of the digital product A′.

The digital product management database is a database that manages a history related to a commercial dealing for each digital product. The database is time series data in which transactions of the commercial dealings of the digital product A′ is arranged according to timestamps. That is, a transaction is associated with a timestamp.

The database management server 90 corresponds to a database entity.

### 2.4. Time Stamping Authority 100

The time stamping authority 100 is an organization certified by the Minister for Internal Affairs and Communications for time stamping operations. In the present embodiment, it is possible to obtain high reliability with respect to the data related to the dealing of the digital product A′ by authenticating the data related to the dealing of the digital product by adding a timestamp of the time stamping authority 100.

### 2.5. Wallet Management Device 60

Since the wallet management device 60 is similar to that of the first embodiment, the description thereof will be omitted.

### Operation of Third Embodiment

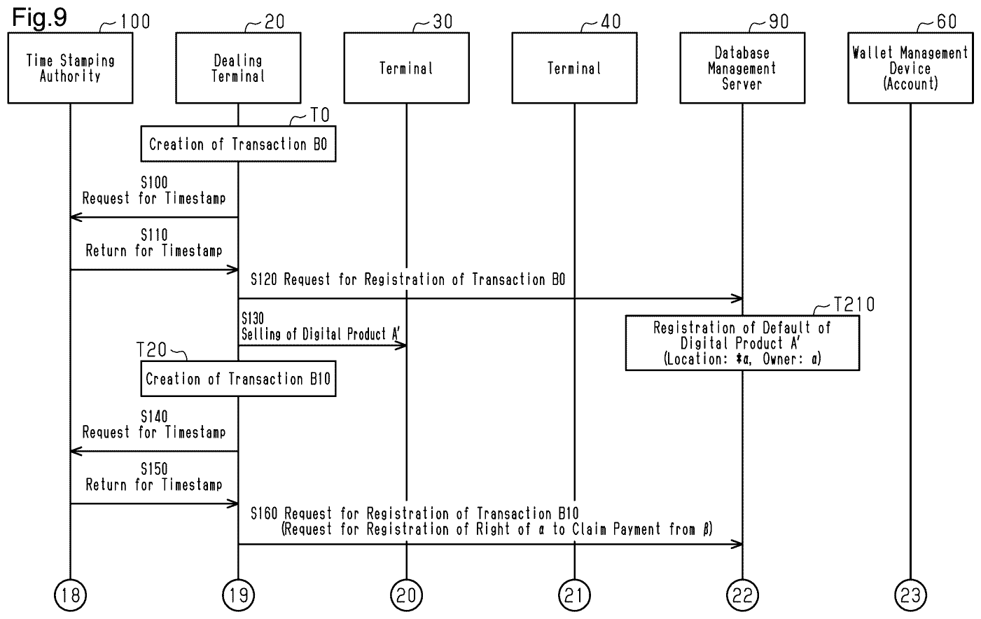

Next, operation of the digital product management support system 10, the dealing terminal 20, and the digital product management support program of the present embodiment will be described with reference to FIGS. 9 to 11. FIGS. 9 to 11 are sequence diagrams illustrating an outline of digital product management support.

### T0: Creation of Transaction B0

As illustrated in FIG. 9, the dealing terminal 20 of the vendor (business operator α) creates a transaction B0. Since the creation of the transaction B0 and the contents of the transaction B0 are similar to those of the first embodiment, the description thereof will be omitted.

### S100: Request for Timestamp, and S110: Return of Timestamp

In S100, the dealing terminal 20 requests the time stamping authority 100 to add a timestamp to the transaction B0 attached with an electronic signature. This request is made by an operation of the input device of the dealing terminal 20.

In S110, the time stamping authority 100 returns the transaction B0 associated with the timestamp to the dealing terminal 20.

### S120: Request for Registration of Transaction B0

As described above, when the transaction B0 with the timestamp is returned, the digital product management support program causes the dealing terminal 20 to request the database management server 90 to register the transaction B0 via the communication network 80.

### T210: Registration of Default Data of Digital Product A′

When there is a registration request of the transaction B0, the database management server 90 registers default data of the digital product A′ in the digital product management database.

As a result, the location *α of the digital product A′ and the fact that the owner of the digital product A′ is the vendor (business operator α) of the digital product A′ are registered in the digital product management database of the database management server 90.

### S130: Selling of Digital Product A′

As illustrated in FIG. 9, when a sales contract is established between the vendor (business operator α) and a business operator (business operator β) who wishes to purchase the digital product A′, digital data including an image of the digital product A′ and the like, and a delivery slip and an invoice are transmitted from the dealing terminal 20 to the terminal 30. This transmission is executed by the processor 22 of the dealing terminal 20 when an input device connected to the input/output interface 26 is operated. The delivery of the digital data including the image of the digital product A′ and the like, and the delivery of the delivery slip and the invoice from the dealing terminal 20 to the terminal 30 means the sale of the digital product A′.

The commercial dealing between the business operator α and the business operator β may be either face-to-face dealing or dealing on a website provided by a server (not illustrated) connected to the communication network 80.

### T20: Creation of Transaction B10

As illustrated in FIG. 9, the dealing terminal 20 of the vendor (business operator α) creates a transaction B10. Since the creation of the transaction B10 and the contents of the transaction B10 are similar to those of the first embodiment, the description thereof will be omitted.

### S140: Request for Timestamp, and S150: Return of Timestamp

In S140, the dealing terminal 20 requests the time stamping authority 100 to add a timestamp to the transaction B10 attached with an electronic signature. This request is made by an operation of the input device of the dealing terminal 20.

In S150, the time stamping authority 100 returns the transaction B10 associated with the timestamp to the dealing terminal 20.

### S160: Request for Registration of Transaction B10

As described above, when the transaction B10 with the timestamp is returned, the digital product management support program causes the dealing terminal 20 to request the database management server 90 to register the transaction B10 via the communication network 80.

The registration request includes a registration request of the owner information of the digital product A′ in which the purchaser of the digital product A′ is the new owner of the digital product A′, and a registration request indicating that the seller of the digital product A′ has the right to claim payment for the digital product A′.

### T220: Additional Registration of Data of Digital Product A′

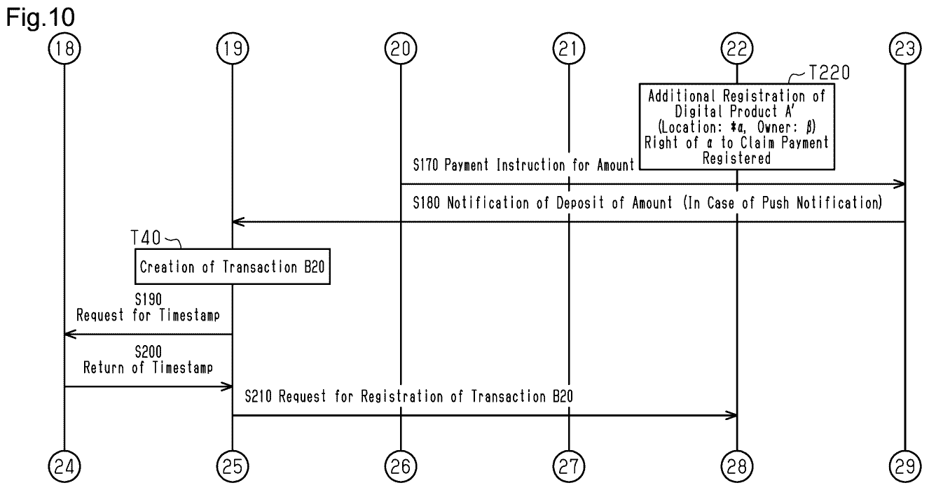

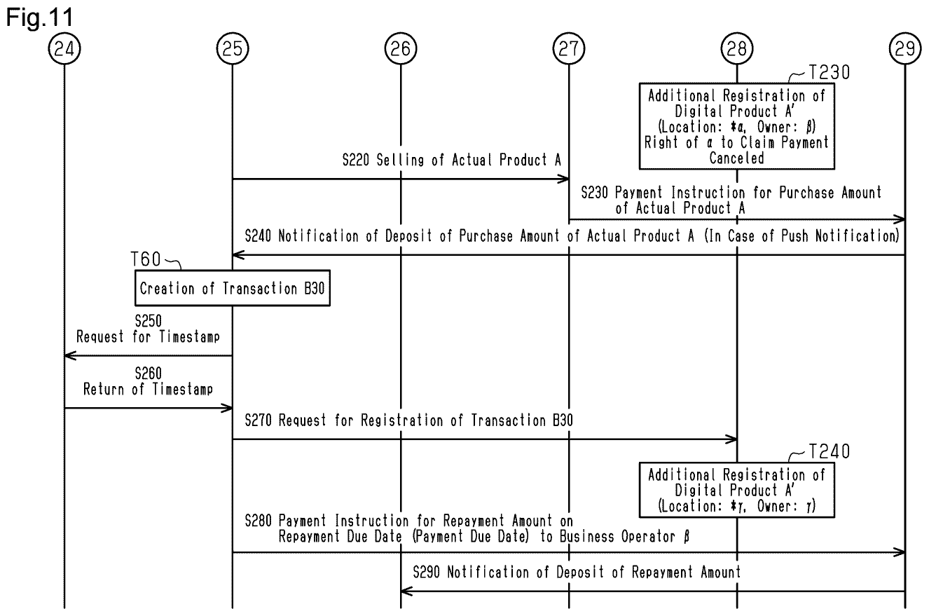

As illustrated in FIG. 10, when there is a registration request of the transaction B10, the database management server 90 additionally registers data of the digital product A′ in the digital product management database.

By the transaction B10, the location *α of the digital product A′, information indicating that the owner of the digital product A′ is the purchaser (business operator β) of the digital product A′, and that the seller of the digital product A′ has the right to claim payment for the digital product A′ are registered in the digital product management database of the database management server 90.

### S170: Payment Instruction for Amount

In S170, the terminal 30 of the business operator β instructs the wallet management device 60 to pay the purchase amount (trade price D) of the digital product A′ to the vendor (business operator α) via the communication network 80. In response to the payment instruction, the wallet management device 60 remits money from the account of the business operator who has given the payment instruction to another wallet management device that manages the account of the vendor (business operator α).

### S180: Notification of Deposit of Amount

In S180, a deposit notification (for example, push notification) of the amount from the business operator β is received via the other wallet management device to the account of the vendor via the communication network 80. The currency to be deposited in the account is a stablecoin or cash.

### T40: Creation of Transaction B20

As illustrated in FIG. 10, when a notification of deposit of the amount from the business operator β to the account of the vendor is received via the communication network 80, the digital product management support program causes the dealing terminal 20 to create a transaction B20.

### Transaction B20

Since the creation and the contents of the transaction B20 are similar to those of the first embodiment, the description thereof will be omitted.

Therefore, in the transaction B20, similarly to the transaction B10, the owner of the digital product A′ is the purchaser (business operator β), and there is no change from the transaction B10. In the transaction B20, the location *α of the digital product A′ is not changed from the transaction B10.

The location *α of the digital product A′ corresponds to the location information of the digital product A′.

### S190: Request for Timestamp, and S200: Return of Timestamp

In S190, the dealing terminal 20 requests the time stamping authority 100 to add a timestamp to the transaction B20 attached with an electronic signature. This request is made by an operation of the input device of the dealing terminal 20.

In S200, the time stamping authority 100 returns the transaction B20 associated with the timestamp to the dealing terminal 20.

### S210: Request for Registration of Transaction B20

As described above, when the transaction B20 with the timestamp is returned, the digital product management support program causes the dealing terminal 20 to request the database management server 90 to register the transaction B20 via the communication network 80.

The registration request includes a registration request indicating that the seller of the digital product A′ does not have a right to claim payment for the digital product A′.

### T230: Additional Registration of Data of Digital Product A′

As illustrated in FIG. 11, when there is a registration request of the transaction B20, the database management server 90 additionally registers data of the digital product A′ in the digital product management database.

As a result, the location *α of the digital product A′, information indicating that the owner of the digital product A′ is the purchaser (business operator β), and that the seller of the digital product A′ does not have the right to claim payment for the digital product A′ are registered in the digital product management database of the database management server 90.

### S220, S230, S240, and T60

S220, S230, S240, and T60 illustrated in FIG. 11 are the same as S16 (selling of the actual product A), S17 (payment instruction for the purchase amount of the actual product A), S18 (notification of deposit of the purchase amount), and T60 (creation of the transaction B30) in the first embodiment, respectively. Therefore, the description of S220, S230, S240, and T60 is omitted.

S250: Request for Timestamp, and S260: Return of Timestamp

In S250 after T60 illustrated in FIG. 11, the dealing terminal 20 requests the time stamping authority 100 to add a timestamp to the transaction B30 attached with an electronic signature. This request is made by an operation of the input device of the dealing terminal 20.

In S260, the time stamping authority 100 returns the transaction B30 associated with the timestamp to the dealing terminal 20.

### S270: Request for Registration of Transaction B30

When the transaction B30 with the timestamp is returned, the digital product management support program causes the dealing terminal 20 to request the database management server 90 to register the transaction B30 via the communication network 80.

The registration request includes a registration request of owner information of the digital product A′ in which the purchaser (business operator γ) of the actual product A is a new owner of the digital product A′, and a registration request of a location of the digital product A′.

### T240: Additional Registration of Data of Digital Product A′

When there is a registration request of the transaction B30, the database management server 90 additionally registers data of the digital product A′ in the digital product management database.

As a result, the location *γ of the digital product A′ and the fact that the owner of the digital product A′ is the purchaser (business operator γ) of the actual product A are registered in the database of the database management server 90.

### S280 and S290

S280 and S290 illustrated in FIG. 11 are the same as S20 (payment instruction for the repayment amount on the repayment due date (payment due date) to the business operator β), and S21 (notification of deposit of the repayment amount) in the first embodiment, respectively. Therefore, the description of S280 and S290 is omitted.

The third embodiment has the following features.

(1) The digital product management support system 10 and the digital product management support system 10 according to the present embodiment request the database management server 90 to register a transaction associated with a timestamp by the time stamping authority 100. Then, the database management server 90 registers the transaction associated with the timestamp in the digital product management database. As a result, since the timestamp is associated with the transaction registered in the digital product management database of the database management server 90, there is no tampering.

### Fourth Embodiment

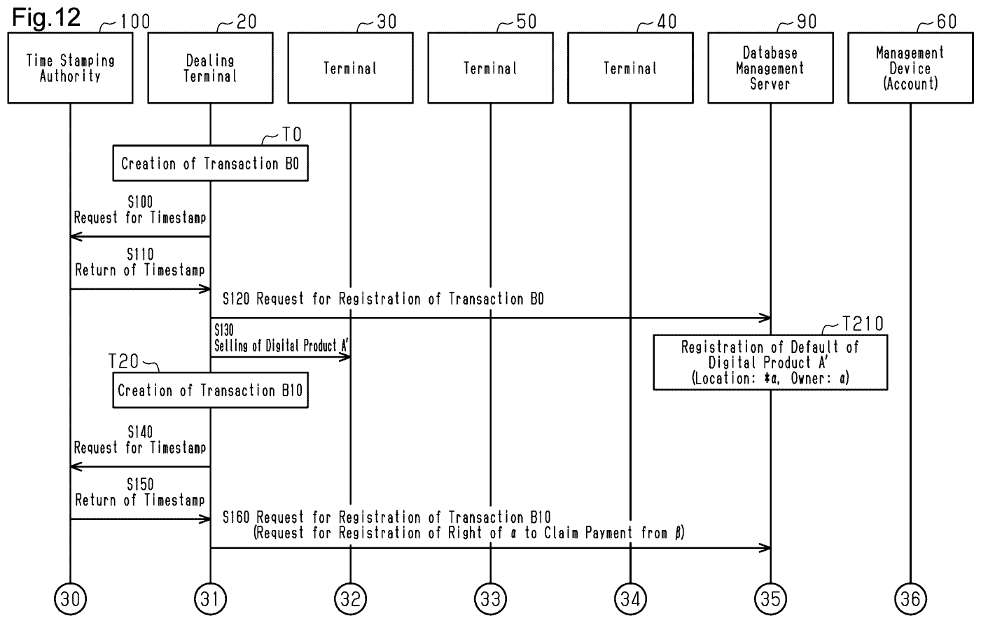

Next, a fourth embodiment will be described with reference to FIGS. 12 to 15. Since the digital product management support system 10, the dealing terminal 20, the terminals 30, 40, and 50, the wallet management device 60, the database management server 90, and the communication network 80 have the same configurations as those of the third embodiment, a detailed description thereof will be omitted.

In the present embodiment, the digital product management support program stored in the storage unit 24 (see FIG. 2) of the terminal 30 is executed by the processor 22, whereby a transaction T270 to be described later can be created. In addition, when the digital product management support program is executed by the processor 22, the terminal 30 can request the database management server 90 to register the transactions T250 and T270 via the communication network 80.

### Operation of Fourth Embodiment

Next, operation of the digital product management support system 10, the dealing terminal 20, and the digital product management support program of the present embodiment will be described with reference to FIGS. 12 to 15. FIGS. 12 to 15 are sequence diagrams illustrating an outline of digital product management support.

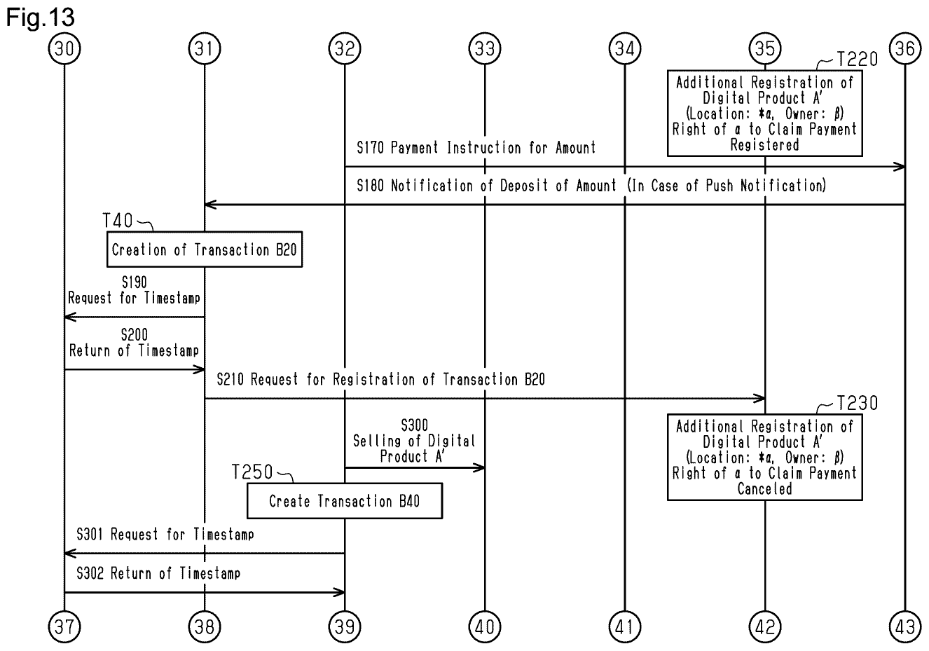

Since the following part from T0 (creation of the transaction B0) in FIGS. 12 to T230 (additional registration of data of the digital product A′) in FIG. 13 is the same processing as that of the third embodiment, the description thereof will be omitted.
T0: Creation of Transaction B0
S100: Request for Timestamp, and S110: Return of Timestamp
S120: Request for Registration of Transaction B0
T210: Registration of Default Data of Digital Product A′
S130: Selling of Digital Product A′
T20: Creation of Transaction B10
S140: Request for Timestamp, and S150: Return of Timestamp
S160: Request for Registration of Transaction B10
T220: Additional Registration of Data of Digital Product A′
S170: Payment Instruction for Amount
S180: Notification of Deposit of Amount
T40: Creation of Transaction B20
S190: Request for Timestamp, and S200: Return of Timestamp
S210: Request for Registration of Transaction B20
T230: Additional Registration of Data of Digital Product A′
S300: Selling of Digital Product A′

As illustrated in FIG. 13, when a sales contract is established between the business operator β and a business operator (business operator β′) who wishes to purchase a new digital product A′, digital data including an image of the digital product A′ and the like, and a delivery slip and an invoice are transmitted from the terminal 30 to the terminal 50. The delivery of the digital data including the image of the digital product A′ and the like, and the delivery of the delivery slip and the invoice from the terminal 30 to the terminal 50 means the sale of the digital product A′.

The commercial dealing between the business operator β and the business operator β′ may be either face-to-face dealing or dealing on a website provided by a server (not illustrated) connected to the communication network 80.

### T250: Creation of Transaction B40

As illustrated in FIG. 13, after the sale of the digital product A′ is completed, the terminal 30 creates the transaction B40. The creation of the transaction B40 is performed by an input operation or the like of the input device of the terminal 30.

Since the contents of the transaction B40 are similar to those of the transaction B40 of the second embodiment, the description thereof will be omitted.

### S301: Request for Timestamp, and S302: Return of Timestamp

In S301, the terminal 30 requests the time stamping authority 100 to add a timestamp to the transaction B40 attached with an electronic signature. This request is made by an operation of the input device of the terminal 30.

In S302, the time stamping authority 100 returns the transaction B40 associated with the timestamp to the terminal 30.

### S303: Request for Registration of Transaction B40

As described above, when the transaction B40 with the timestamp is returned, the digital product management support program causes the terminal 30 to request the database management server 90 to register the transaction B40 via the communication network 80.

### T260: Additional Registration of Data of Digital Product A′

When there is a registration request of the transaction B40, the database management server 90 additionally registers data of the digital product A′ in the digital product management database.

As a result, the location *α of the digital product A′ and the information indicating that the owner of the digital product A′ is the purchaser (business operator β′) of the digital product A′ are registered in the digital product management database of the database management server 90.

### S304: Payment Instruction for Amount

In S304, the terminal 50 of the business operator β′ instructs the wallet management device 60 to pay the purchase amount (trade price D′) of the digital product A′ to the vendor (business operator β) via the communication network 80. In response to the payment instruction, the wallet management device 60 remits money from the account of the business operator who has given the payment instruction to another wallet management device that manages the account of the vendor (business operator β).

### S305: Notification of Deposit of Amount

In S305, a deposit notification (for example, push notification) of the amount from the business operator β′ is received via the other wallet management device to the account of the vendor via the communication network 80. The currency to be deposited in the account is a stablecoin or cash.

### T270: Creation of Transaction B50

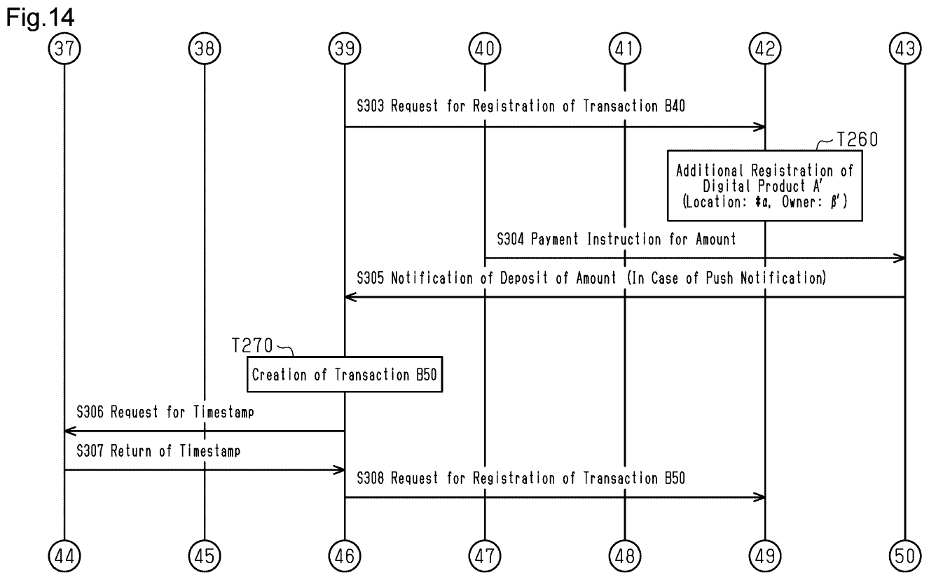

As illustrated in FIG. 14, when a notification of deposit of the amount from the business operator β′ to the account of the vendor via the communication network 80, the digital product management support program causes the terminal 30 to create the transaction B50.

Since the contents of the transaction B50 are similar to those of the transaction B50 of the second embodiment, the description thereof will be omitted.

### S306: Request for Timestamp, and S307: Return of Timestamp

In S306, the terminal 30 requests the time stamping authority 100 to add a timestamp to the transaction B50 attached with an electronic signature. This request is made by an operation of the input device of the terminal 30.

In S307, the time stamping authority 100 returns the transaction B50 associated with the timestamp to the terminal 30.

### S308: Request for Registration of Transaction B50

As described above, when the transaction B50 with the timestamp is returned, the digital product management support program causes the terminal 30 to request the database management server 90 to register the transaction B50 via the communication network 80.

### T280: Additional Registration of Data of Digital Product A′

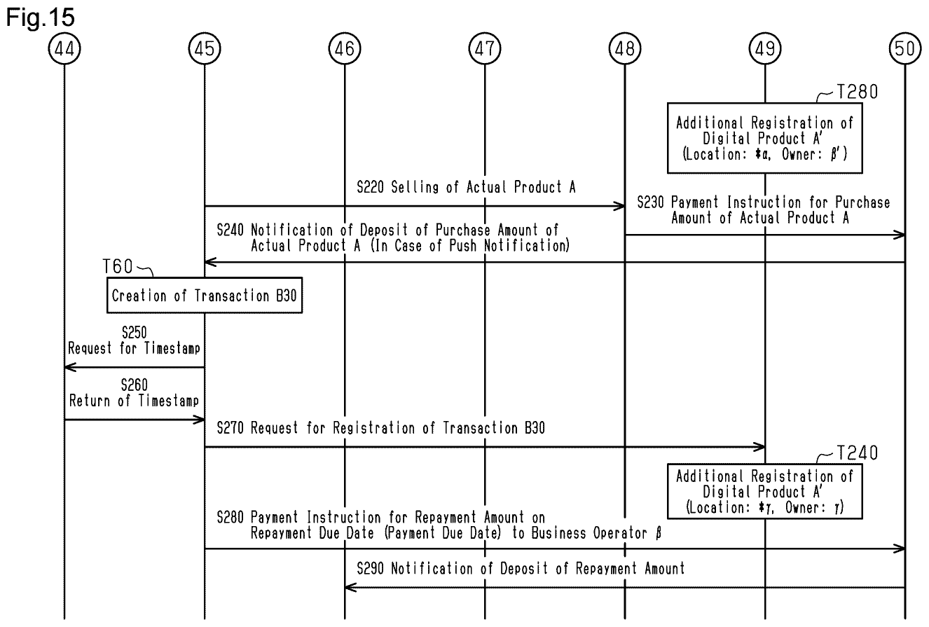

As illustrated in FIG. 15, when there is a registration request of the transaction B50, the database management server 90 additionally registers data of the digital product A′ in the digital product management database.

As a result, the history information indicating that the amount has been deposited from the business operator β′, the location *α of the digital product A′ and the information indicating that the owner of the digital product A′ is the purchaser (business operator β′) of the digital product A′ are registered in the digital product management database of the database management server 90.

### S220 to S290 and T240: Additional Registration of Data of Digital Product A′

S220 to S290 and T240 (additional registration of data of the digital product A′) in FIG. 15 are the same as S220 to S290 and T240 (additional registration of data of the digital product A′) in the third embodiment, respectively. Therefore, the description thereof is omitted.

The fourth embodiment has the same effects as those of the third embodiment.

### Modifications of Third Embodiment and Fourth Embodiment

Although not illustrated, modifications of the third embodiment and the fourth embodiment in a case in which the location of the actual product A is changed before S130 (selling of the digital product A′).

Each time there is a change in the location of the actual product A before S130 (selling of the digital product A′) in FIGS. 9 and 12, a new transaction B0 is created in the dealing terminal 20. The new transaction B0 includes digital product related information including the changed location of the digital product A′, actual product related information including the changed location of the actual product A, and transaction related information.

Then, the dealing terminal 20 requests the time stamping authority 100 to add a timestamp to the new transaction B0 attached with an electronic signature. This request is made by an operation of the input device of the dealing terminal 20.

The time stamping authority 100 returns the new transaction B0 associated with the timestamp to the dealing terminal 20.

When the transaction B0 with the timestamp is returned, the digital product management support program causes the dealing terminal 20 to request the database management server 90 to register the transaction B0 via the communication network 80.

When there is a registration request of the new transaction B0, the database management server 90 registers default data of the digital product A′ in the digital product management database.

As a result, the new location *α of the digital product A′ and the fact that the owner of the digital product A′ is the vendor (business operator α) of the digital product A′ are registered in the digital product management database of the database management server 90.

The present embodiment can be modified and implemented as follows.

The present embodiment and the following modifications can be implemented in combination with each other within a range not technically contradictory.

Although the blockchain is adopted in the distributed ledger system 70 of the first embodiment and the third embodiment, the disclosure is not limited thereto. Instead of the blockchain, a directed acyclic graph (DAG) may be adopted.

In the DAG, when a dealer creates a new transaction in association with a previously published unapproved transaction, the dealer approves the previously published unapproved transaction. Therefore, the transaction created by the dealer will also be approved by the fact that there is an unapproved transaction to be published later.

In the DAG, when an unapproved transaction equal to or greater than a threshold is directly or indirectly approved, a new transaction created by the user is considered to be agreed in the network by a consensus algorithm.

The DAG differs from the blockchain in the consensus algorithm, but the same transaction configuration can be adopted. That is, the processing using the blockchain as the distributed ledger system and the processing using the DAG can be performed using the same transaction.

In the second embodiment and the fourth embodiment, the digital product A′ is transferred from the business operator β to a single business β′ by purchase, but the business β′ is not limited to a single business operator and may be multiple business operators.

In the embodiments, the deposit to an account is made in a stablecoin or cash, but the deposit is not limited thereto, and may be made in credit or point.

In the modifications of the embodiments, the case in which there is a change in the location of the actual product A has been described. In a case in which the owner himself/herself is changed, the changed owner may update and register the changed owner information in the distributed ledger system 70 or the database management server 90.

In the embodiment, the case in which the actual product A is a single product has been described. However, even if the actual product A is multiple actual products, if each of the actual products A is individually managed and sold to multiple business operators γ, it is similar to the case of a single product.

When there are multiple actual products A to be sold by the business operator α and the actual products A to be sold are not sold out to the business operator γ, the business operator α may buy back the sold digital products A′ from the business operator β based on the sales contract between the business operators α and β. Alternatively, the business operator β may continue to store the digital product A′ and continue to entrust sales of the multiple actual products A.

In addition, the embodiments are not limited to the case in which the number of the actual products A is singular, and the digital product A′ associated with the actual product A is a single product. In a case in which the number of the actual product A is a singular and there are multiple digital products A′ associated with the actual product A, it is sufficient that the total amount of the multiple digital products A′ is the same as the amount of the actual product A.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A digital product management support method for causing a computer of a dealing terminal to execute the following steps upon dealing of a digital product associated with an actual product, the method comprising:
when there is a commercial dealing of the digital product, requesting, by the computer, a database entity under a communication network to register a transaction including owner information in which a purchaser of the digital product is a new owner of the digital product and a fact that a seller of the digital product has a right to claim payment for the digital product;
in a case in which a deposit notification of a purchase amount of the digital product from the purchaser of the digital product is received via the communication network, requesting, by the computer, the database entity to register a transaction including a fact that the seller of the digital product does not have the right to claim payment;
in a case in which the actual product is sold, requesting the database entity to register a transaction including a fact that the purchaser of the actual product is an owner of the digital product and a location of the actual product is registered as a location of the digital product; and
on a payment due date according to a sales contract with the purchaser of the digital product based on the dealing of the digital product, notifying, by the computer, a terminal of a financial institution of payment of a sales amount of the digital product to an account of the purchaser of the digital product via the communication network.

2. The digital product management support method according to claim 1, wherein
the database entity is a distributed ledger system in which multiple node computers are connected to each other wirelessly or by wire via a P2P network and share a blockchain, and
the database entity is configured to associate a timestamp with the transaction when there is a registration request of the transaction.

3. The digital product management support method according to claim 1, wherein
the transaction is associated with a timestamp, and
the database entity is a database management server.

4. A digital product management support device communicable with multiple terminals and a database entity via a communication network and configured to support management of dealing of a digital product associated with an actual product, the device comprising:
a first registration request unit including a processor configured to, when there is a commercial dealing of the digital product, request the database entity under the communication network to register a transaction including owner information in which a purchaser of the digital product is a new owner of the digital product and a fact that a seller of the digital product has a right to claim payment for the digital product;
a second registration request unit including a processor configured to, in a case in which a deposit notification of a purchase amount of the digital product from the purchaser of the digital product is received via the communication network, request the database entity to register a transaction including a fact that the seller of the digital product does not have the right to claim payment;
a third registration request unit including a processor configured to, in a case in which the actual product is sold, request the database entity to register a transaction including a fact that the purchaser of the actual product is an owner of the digital product and a location of the actual product is registered as a location of the digital product; and
a payment notification unit including a processor configured to request a terminal of a financial institution to pay a sales amount of the digital product to an account of the purchaser of the digital product via the communication network on a payment due date according to a sales contract with the purchaser of the digital product based on the dealing of the digital product.

5. A computer-readable medium recording a digital product management support program implemented by multiple terminals and a computer communicable with a database entity via a communication network, the digital product management support program including an instruction that causes the computer to:
when there is a commercial dealing of a digital product associated with an actual product, request the database entity under the communication network to register a transaction including owner information in which a purchaser of the digital product is a new owner of the digital product and a fact that a seller of the digital product has a right to claim payment for the digital product;
in a case in which a deposit notification of a purchase amount of the digital product from the purchaser of the digital product is received via the communication network, request the database entity to register a transaction including a fact that the seller of the digital product does not have the right to claim payment;
in a case in which the actual product is sold, request the database entity to register a transaction including a fact that the purchaser of the actual product is an owner of the digital product and a location of the actual product is registered as a location of the digital product; and
notify a terminal of a financial institution of payment of a sales amount of the digital product to an account of the purchaser of the digital product via the communication network on a payment due date according to a sales contract with the purchaser of the digital product based on the dealing of the digital product.

6. A digital product management support system, comprising a digital product management support device, multiple terminals, and a database entity that are connected via a communication network, the digital product management support device including:
a first registration request unit including a processor configured to, when there is a commercial dealing of a digital product associated with an actual product, request the database entity under the communication network to register a transaction including owner information in which a purchaser of the digital product is a new owner of the digital product and a fact that a seller of the digital product has a right to claim payment for the digital product;
a second registration request unit including a processor configured to, in a case in which a deposit notification of a purchase amount of the digital product from the purchaser of the digital product is received via the communication network, request the database entity to register a transaction including a fact that the seller of the digital product does not have the right to claim payment;
a third registration request unit including a processor configured to, in a case in which the actual product is sold, request the database entity to register a transaction including a fact that the purchaser of the actual product is an owner of the digital product and a location of the actual product is registered as a location of the digital product; and
a payment notification unit including a processor configured to request a terminal of a financial institution to pay a sales amount of the digital product to an account of the purchaser of the digital product via the communication network on a payment due date according to a sales contract with the purchaser of the digital product based on the dealing of the digital product,
wherein the database entity is configured to perform processing according to a registration request of the first registration request unit, a registration request of the second registration request unit, and a registration request of the third registration request unit.
